(19) United States
(12) Patent Application Publication
(10) Pub. No.: US 2019/0138023 A1
(43) Pub. Date: May 9, 2019

(54) MOVABLE BODY, IMAGE CAPTURE SYSTEM USING MOVABLE BODY, SERVER, AND IMAGE CAPTURING METHOD USING MOVABLE BODY

(71) Applicant: TOYOTA JIDOSHA KABUSHIKI KAISHA, Toyota-shi (JP)

(72) Inventors: Toshiaki NIWA, Okazaki-shi (JP); Naomi KATAOKA, Nagoya-shi (JP); Yasuhiro BABA, Kamo-gun (JP); Katsuhiko YOUROU, Toyonaka-shi (JP); Kazuyuki KAGAWA, Nisshin-shi (JP)

(73) Assignee: TOYOTA JIDOSHA KABUSHIKI KAISHA, Toyota-shi (JP)

(21) Appl. No.: 16/154,824

(22) Filed: Oct. 9, 2018

(30) Foreign Application Priority Data
Nov. 7, 2017 (JP) 2017-214876

(51) Int. Cl. G05D 1/02; G05D 1/00; B60R 11/04

(52) U.S. Cl. CPC G05D 1/0246; G05D 1/0287; G05D 2201/0213; B60R 11/04; G05D 1/0088

(57) ABSTRACT

Each vehicle is configured to perform automated driving and includes a camera and an ECU. The camera is configured to capture an image of a situation outside the vehicle. The ECU receives an image capture request including an image capture location through a communication module. The ECU performs control for causing the vehicle to move to the image capture location and capturing an image of a situation outside the vehicle by the camera in accordance with the image capture request.

This nonprovisional application is based on Japanese Patent Application No. 2017-214876 filed on Nov. 7, 2017, with the Japan Patent Office, the entire contents of which are hereby incorporated by reference.

### BACKGROUND

### Field

The present disclosure relates to a movable body including an image capturing device capable of capturing an image of a situation outside the movable body, an image capture system using the movable body, a server, and an image capturing method using the movable body.

### Description of the Background Art

Various types of systems for effectively utilizing an in-vehicle camera capable of capturing an image of a situation outside a vehicle have been proposed. For example, Japanese Patent Laying-Open No. 2016-139865 discloses a security system using an in-vehicle camera. Japanese Patent Laying-Open No. 2016-139865 describes that in order to monitor an abnormal situation around a vehicle, an image around the vehicle captured by an in-vehicle camera is transmitted to an external monitoring device when the vehicle is parked.

The system described in Japanese Patent Laying-Open No. 2016-139865 can transmit an image around the vehicle which is captured through the in-vehicle camera to the external device (monitoring device) to remotely view a situation outside the vehicle. This system, however, fails to obtain an image of a location remote from a position at which the vehicle is parked.

### SUMMARY

The present disclosure has been made to solve the foregoing problem and has an object to provide a movable body for obtaining an image of a desired location adhering to an image capture request, an image capture system using the movable body, a server, and an image capturing method using the movable body.

A movable body according to the present disclosure is a movable body configured to perform automated driving, and includes an image capturing device configured to capture an image of a situation outside the movable body, a communication device configured to communicate outside of the movable body, and a controller configured to receive an image capture request including an image capture location through the communication device. The controller is configured to perform, in accordance with the image capture request, control for causing the movable body to move to the image capture location and capturing an image of a situation outside the movable body by the image capture device.

The above configuration allows the movable body to move to a desired image capture location adhering to an image capture request to obtain an image (which may be a still image or a moving image) of the location. For example, a movable body moves to a location impacted by a disaster, a location with a windstorm associated with an approaching typhoon, or any other location to capture an image of such a location, allowing a user to view the image of the location remotely without actually visiting the location.

The movable body may be configured to perform driverless driving. The controller may perform the above control in accordance with an image capture request during a driverless mode in which the movable body is caused to travel by the driverless driving.

A movable body in a driverless state which is not used by its owner can accordingly be used effectively without hindering the utilization of the movable body by its owner.

The controller may be configured to perform the control in accordance with an image capture request when the owner of the movable body permits the execution of the above control.

The movable body can accordingly be prevented from moving to an image capture location adhering to the image capture request against the intention of the owner of the movable body.

An image capture system of the present disclosure is an image capture system using a movable body, and includes a plurality of movable bodies each configured to perform automated driving, and a server configured to communicate with the plurality of movable bodies. Each of the plurality of movable bodies includes an image capturing device configured to capture an image of a situation outside the movable body. The server is configured to (i) when receiving an image capture request including an image capture location, select an image capture movable body capable of moving to the image capture location in accordance with the image capture request from among the plurality of movable bodies, and (ii) transmit, to the image capture movable body, an instruction for moving the image capture movable body to the image capture location and capturing an image of a situation outside the image capture movable body by the image capturing device. The image capture movable body transmits, to the server, an image captured by the image capturing device in accordance with the instruction.

The above configuration allows the movable body to move to a desired image capture location adhering to an image capture request to remotely obtain an image (which may be a still image or a moving image) of the location. For example, the movable body is moved to a location impacted by a disaster, a location with a windstorm associated with an approaching typhoon, or any other location to take an image of such a location, allowing a user to view the image of the location remotely without actually visiting the location.

The server may select a movable body closest to the image capture location from among a plurality of movable bodies as an image capture movable body.

The image capture movable body can accordingly be moved to a desired image capture location adhering to the image capture request on the shortest route to obtain an image of the location.

Each movable body may be configured to perform driverless driving. The server may select an image capture movable body from among movable bodies in the driverless mode that allows a movable body to travel by the driverless driving.

Effective utilization of the movable body in the driverless mode is accordingly enabled without bothering an owner of the movable body who is driving the movable body.

The server may select, as an image capture movable body, a movable body permitted to perform image capturing adhering to the image capture request by the owner of the movable body from among a plurality of movable bodies.

The movable body can accordingly be prevented from moving to the image capture location adhering to the image capture request against the intention of the owner of the movable body.

A server of the present disclosure includes a communication device configured to communicate with a plurality of movable bodies each configured to perform automated driving, and a processor. Each of the plurality of movable bodies includes an image capturing device configured to capture an image of a situation outside the movable body. The processor is configured to, when receiving an image capture request including an image capture location through the communication device, select an image capture movable body capable of moving to the image capture location in accordance with the image capture request from among the plurality of movable bodies, and to transmit, through the communication device to the image capture movable body, an instruction for moving the image capture movable body to the image capture location and capturing an image of a situation outside the image capture movable body by the image capturing device.

An image capturing method of the present disclosure is an image capturing method using a movable body configured to perform automated driving. The movable body includes an image capturing device configured to capture an image of a situation outside the movable body. The image capturing method includes receiving an image capture request including an image capture location, causing the movable body to move to the image capture location in accordance with the image capture request, and causing the image capturing device to capture an image of a situation outside the movable body at the image capture location.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 schematically shows an entire configuration of an image capture system according to the present embodiment.

FIG. 2 shows an example of a configuration of a vehicle.

FIG. 3 shows configurations of a controller of the vehicle and a server in greater detail.

FIG. 4 is a sequence diagram showing exchange of information among respective elements of the image capture system according to the present embodiment.

FIG. 5 shows a configuration of data stored in a user information DB of the server.

FIG. 6 shows a configuration of data stored in a vehicle information DB of the server.

FIG. 7 is a flowchart for illustrating a procedure of processes performed by a processor of the server.

FIG. 8 is a flowchart for illustrating a procedure of processes performed by a controller of the vehicle.

FIG. 9 is a flowchart for illustrating a procedure of processes performed by a controller of a server in a modification.

### DESCRIPTION OF THE PREFERRED EMBODIMENTS

The following describes embodiments of the present disclosure with reference to figures in detail. It should be noted that the same or corresponding portions are given the same reference characters and are not described repeatedly.

<System Configuration>

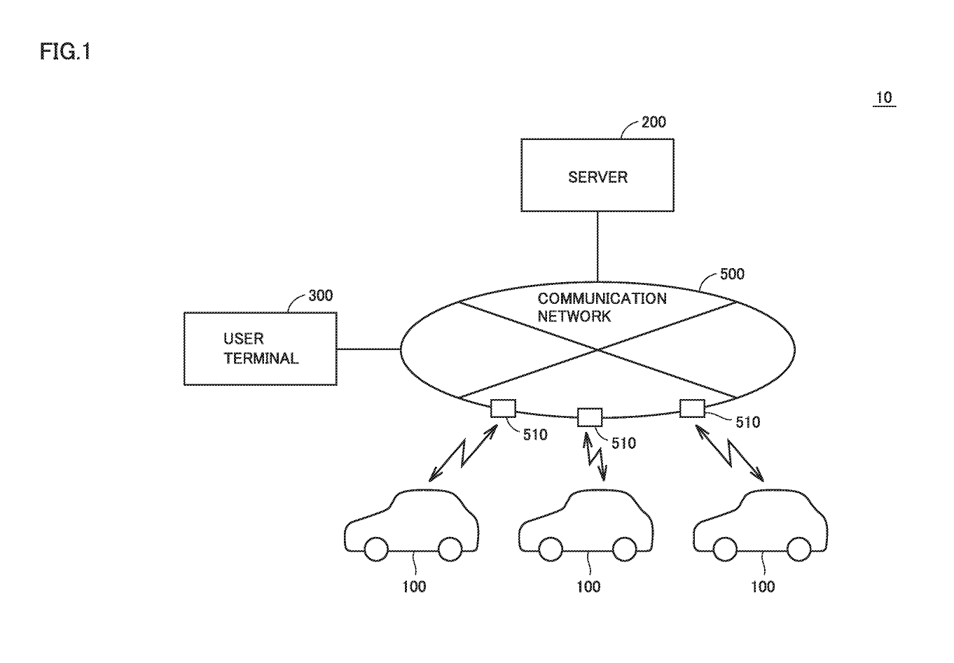

FIG. 1 schematically shows an entire configuration of an image capture system 10 according to the present embodiment. With reference to FIG. 1, image capture system 10 includes a plurality of electrically powered vehicles (hereinafter, also simply referred to as “vehicles”) 100, a server 200, and a user terminal 300. Each of vehicles 100, server 200, and user terminal 300 are configured to communicate with one another through a communication network 500 such as the Internet or a telephone line. It should be noted that each vehicle 100 is configured to send and receive information to and from a base station 510 of communication network 500 through wireless communication.

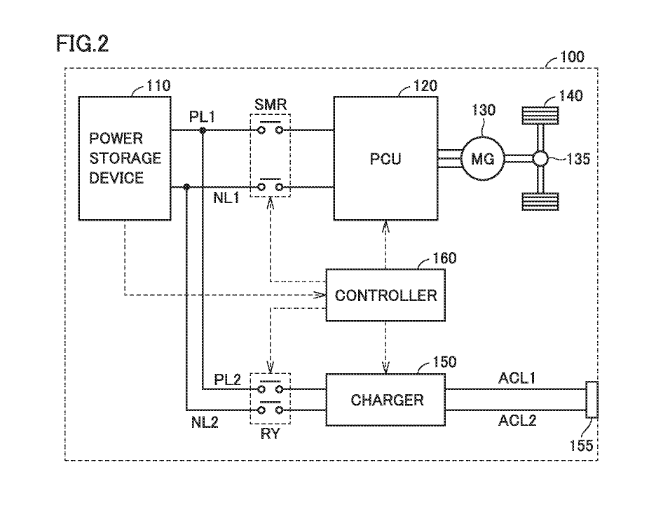

Each vehicle 100 is a movable body configured to perform automated driving. Each vehicle 100 is configured to generate driving power for traveling using electric power from a power storage device mounted thereon as described later with reference to FIG. 2. In the present embodiment, vehicle 100 is further configured to allow the power storage device to be charged using electric power supplied from a power supply external to the vehicle, and vehicle 100 is an electric vehicle, a so-called plug-in hybrid vehicle, or the like, for example. It should be noted that vehicle 100 is not necessarily limited to such a vehicle having a power storage device that can be charged using a power supply external to the vehicle, and may be a hybrid vehicle that does not have a function of charging the power storage device using a power supply external to the vehicle.

Server 200 communicates with each vehicle 100 and user terminal 300 through communication network 500, and sends and receives various types of information to and from each vehicle 100 and user terminal 300. Operations of server 200 will be described in detail later.

User terminal 300 is a terminal of a user who wishes to utilize image capture system 10 using vehicle 100. User terminal 300 is, for example, a mobile terminal such as a smartphone. The user who wishes to utilize image capture system 10 can make an image capture request for capturing an image of a desired capture location using vehicle 100 from user terminal 300 (described in detail later).

FIG. 2 shows an example of a configuration of vehicle 100. With reference to FIG. 2, vehicle 100 includes a power storage device 110, a system main relay SMR, a PCU (Power Control Unit) 120, a motor generator 130, a power transmission gear 135, and driving wheels 140. Vehicle 100 further includes a charger 150, an inlet 155, a charging relay RY, and a controller 160.

Power storage device 110 is a power storage component configured to be chargeable/dischargeable. Power storage device 110 includes a secondary battery such as a lithium ion battery or a nickel-hydrogen battery, or includes a power storage element such as an electric double layer capacitor, for example. Via system main relay SMR, power storage device 110 supplies PCU 120 with electric power for generating driving power of vehicle 100. Further, power storage device 110 stores electric power generated by motor generator 130. Power storage device 110 outputs, to controller 160, detection values of voltage and current of power storage device 110 detected by a sensor (not shown).

PCU 120 is a driving device for driving motor generator 130, and includes a power converting device such as a converter, an inverter, or the like (all not shown). PCU 120 is controlled by a control signal from controller 160 and converts DC power received from power storage device 110 into AC power for driving motor generator 130.

Motor generator 130 is an AC rotating electrical machine, such as a permanent-magnet type synchronous motor including a rotor having a permanent magnet embedded therein. Output torque from motor generator 130 is transmitted to driving wheels 140 via power transmission gear 135, which is constituted of a speed reducer and a power split device. In this way, vehicle 100 travels. Moreover, motor generator 130 is capable of generating electric power using rotation power of driving wheels 140 when vehicle 100 operates for braking. The electric power thus generated is converted by PCU 120 into charging power for power storage device 110.

It should be noted that in a hybrid vehicle including an engine (not shown) in addition to motor generator 130, required vehicle driving power is generated by operating the engine and motor generator 130 cooperatively. In this case, power storage device 110 can also be charged using electric power generated by rotation of the engine.

Charger 150 is connected to power storage device 110 through charging relay RY. Moreover, charger 150 is connected to inlet 155 by power lines ACL1, ACL2. Charger 150 converts electric power supplied from the power supply, which is external to the vehicle and is electrically connected to inlet 155, into electric power with which power storage device 110 can be charged.

Controller 160 includes an ECU (Electronic Control Unit), various sensors, a navigation device, a communication module, and the like (not shown in FIG. 2), receives signals from a sensor group, outputs a control signal to each device, and controls vehicle 100 and each device. Controller 160 performs various types of control for performing automated driving of vehicle 100 (such as driving control, braking control, and steering control). Controller 160 generates control signals for controlling PCU 120, a steering device (not shown), charger 150, and the like. The configuration of controller 160 will be described in detail later.

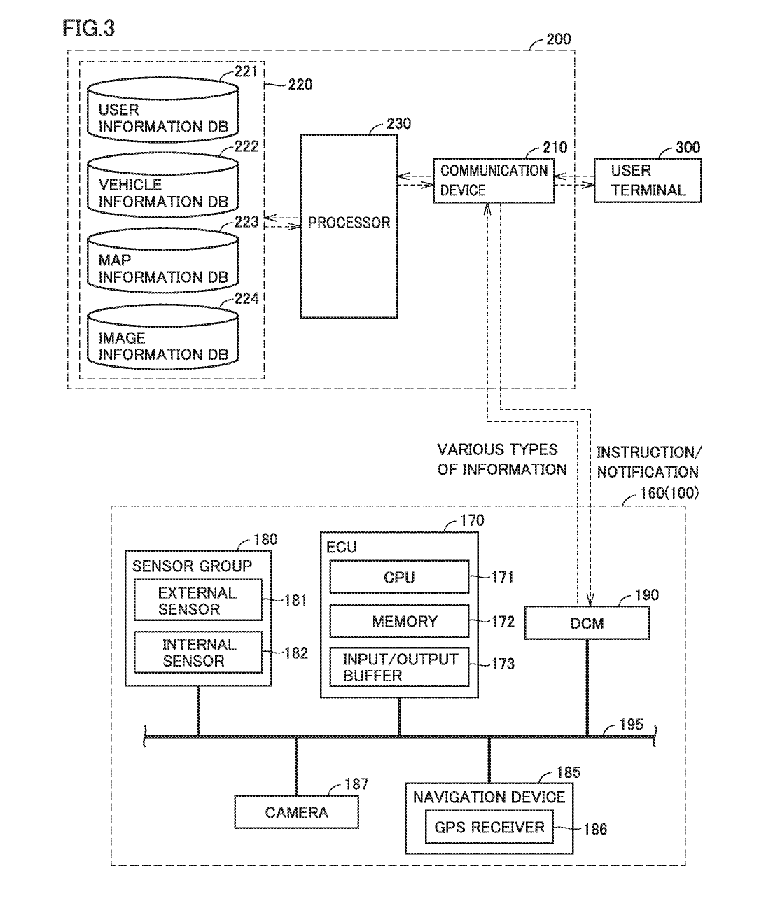

FIG. 3 shows configurations of controller 160 of vehicle 100 and server 200 in greater detail. With reference to FIG. 3, controller 160 of vehicle 100 includes an ECU 170, a sensor group 180, a navigation device 185, a camera 187, and a communication module 190. ECU 170, sensor group 180, navigation device 185, camera 187, and communication module 190 are connected to one another via an in-vehicle wired network 195 such as a CAN (Controller Area Network).

ECU 170 includes a CPU (Central Processing Unit) 171, a memory 172, and an input/output buffer 173. In response to a signal from each sensor of sensor group 180, ECU 170 controls devices to bring vehicle 100 into a desired state. For example, in a driverless mode in which vehicle 100 is caused to travel by driverless driving, ECU 170 performs various types of control for implementing the driverless driving of vehicle 100 by controlling PCU 120 (FIG. 2) serving as a driving device and the steering device (not shown).

ECU 170 receives detection values of voltage and current of power storage device 110, and calculates an SOC (State Of Charge) of power storage device 110 based on these detection values. ECU 170 further transmits, to server 200 through communication module 190, an image captured by camera 187 in response to an image capture request from server 200.

It should be noted that “driverless driving” in the driverless mode refers to driving in which driving operations of vehicle 100 such as acceleration, deceleration, and steering are performed without user's driving operations. Specifically, this vehicle 100 is configured to perform full-automated driving defined as “Level 5”. That is, in the driverless driving by ECU 170, a driver does not need to ride on the vehicle under all the situations.

Therefore, controller 160 includes sensor group 180 to detect situations inside and outside vehicle 100. Sensor group 180 includes an external sensor 181 configured to detect a situation outside vehicle 100, and an internal sensor 182 configured to detect information corresponding to a traveling state of vehicle 100 and detect a steering operation, an accelerating operation, and a braking operation.

External sensor 181 includes a camera, a radar, a LIDAR (Laser Imaging Detection And Ranging), and the like, for example (all not shown). The camera captures an image of a situation outside vehicle 100 and outputs, to ECU 170, captured-image information regarding the situation outside vehicle 100. The radar transmits electric wave (for example, millimeter wave) to surroundings of vehicle 100 and receives electric wave reflected by an obstacle to detect the obstacle. Then, the radar outputs, to ECU 170, a distance to the obstacle and a direction of the obstacle as obstacle information regarding the obstacle. The LIDAR transmits light (typically, ultraviolet rays, visible rays, or near infrared rays) to surroundings of vehicle 100 and receives light reflected by an obstacle to measure a distance to the reflecting point and detect the obstacle. The LIDAR outputs, to ECU 170, the distance to the obstacle and a direction of the obstacle as obstacle information, for example.

Internal sensor 182 includes a vehicle speed sensor, an acceleration sensor, a yaw rate sensor, and the like, for example (all not shown). The vehicle speed sensor is provided at a wheel of vehicle 100 or a drive shaft that is rotated together with the wheel, detects a rotating speed of the wheel, and outputs vehicle speed information including the speed of vehicle 100 to ECU 170. The acceleration sensor includes a forward/backward acceleration sensor configured to detect acceleration in a forward/backward direction of vehicle 100, and a lateral acceleration sensor configured to detect lateral acceleration of vehicle 100, for example. The acceleration sensor outputs acceleration information including both the accelerations to ECU 170. The yaw rate sensor detects a yaw rate (rotation angle speed) around the vertical axis of the center of gravity of vehicle 100. The yaw rate sensor is, for example, a gyro sensor, and outputs yaw rate information including the yaw rate of vehicle 100 to ECU 170.

Navigation device 185 includes a GPS receiver 186 configured to specify a position of vehicle 100 based on electric waves from satellites (not shown). Navigation device 185 performs various types of navigation processes of vehicle 100 using the positional information (GPS information) of vehicle 100 specified by GPS receiver 186. Specifically, navigation device 185 calculates a traveling route (expected traveling route or target route) from the current position of vehicle 100 to a destination based on GPS information of vehicle 100 and road map data stored in the memory (not shown), and outputs information of the target route to ECU 170.

Camera 187 captures an image of a situation outside vehicle 100. An image captured by camera 187 may be a still image or a moving image. The image captured by camera 187 is transmitted to server 200 via communication module 190. It should be noted that camera 187 may be a camera included in external sensor 181 of sensor group 180.

Communication module 190 is an in-vehicle DCM (Data Communication Module), and is configured to perform bidirectional data communication with communication device 210 of server 200 via communication network 500 (FIG. 1).

Server 200 includes a communication device 210, a storage device 220, and a processor 230. Communication device 210 is configured to perform bidirectional data communication with communication module 190 of vehicle 100 and user terminal 300 via communication network 500.

Storage device 220 includes a user information database (DB) 221, a vehicle information database (DB) 222, a map information database (DB) 223, and an image information database (DB) 224. User information DB 221 stores information of a user who utilizes this image capture system 10. A user who wishes to utilize image capture system 10 can utilize image capture system 10 by registering himself/herself as a member in advance, and information of the user who has registered as a member is stored in user information DB 221. A data configuration of user information DB 221 will be described later.

Vehicle information DB 222 stores information of each vehicle 100 utilized in this image capture system 10. Each vehicle 100 to be utilized in image capture system 10 can be utilized in image capture system 10 through a registration procedure in advance. Information of vehicle 100 thus registered is stored in vehicle information DB 222. A data configuration of vehicle information DB 222 will also be described later.

Map information DB 223 stores data about map information. Image information DB 224 stores images captured by camera 187 of vehicle 100 that has moved to an image capture location in accordance with an image capture request from user terminal 300.

When receiving an image capture request from user terminal 300 through communication device 210, processor 230 associates information about the image capture request (such as an image capture location and an image capture date and time) with the information of a user of user terminal 300, and stores this information in user information DB 221. Processor 230 then selects a vehicle 100 suitable for image capturing with reference to the vehicle information stored in vehicle information DB 222, and transmits, to the selected vehicle 100, a request for vehicle dispatch to the image capture location and image capturing at the image capture location.

<Image Capturing Method Using Vehicle 100>

In the present embodiment, when image capturing at a desired location is requested from a user terminal 300 of a user who wishes to utilize image capture system 10, a vehicle 100 that can move to an image capture location is selected from among a plurality of registered vehicles 100, and the selected vehicle 100 moves to the image capture location. Then, camera 187 of vehicle 100 that has moved to the image capture location captures an image of a situation outside vehicle 100, and the captured image is transmitted to server 200.

Consequently, vehicle 100 moves to the desired image capture location adhering to an image capture request from the user, thus obtaining an image (which may be a still image or a moving image) of the location. For example, vehicle 100 is moved to a location impacted by a disaster, a location with a windstorm associated with an approaching typhoon, or any other location to capture an image of such a location, allowing the user to view the image of the location remotely without actually visiting the location. Control of image capture system 10 according to the present embodiment will be described in detail later.

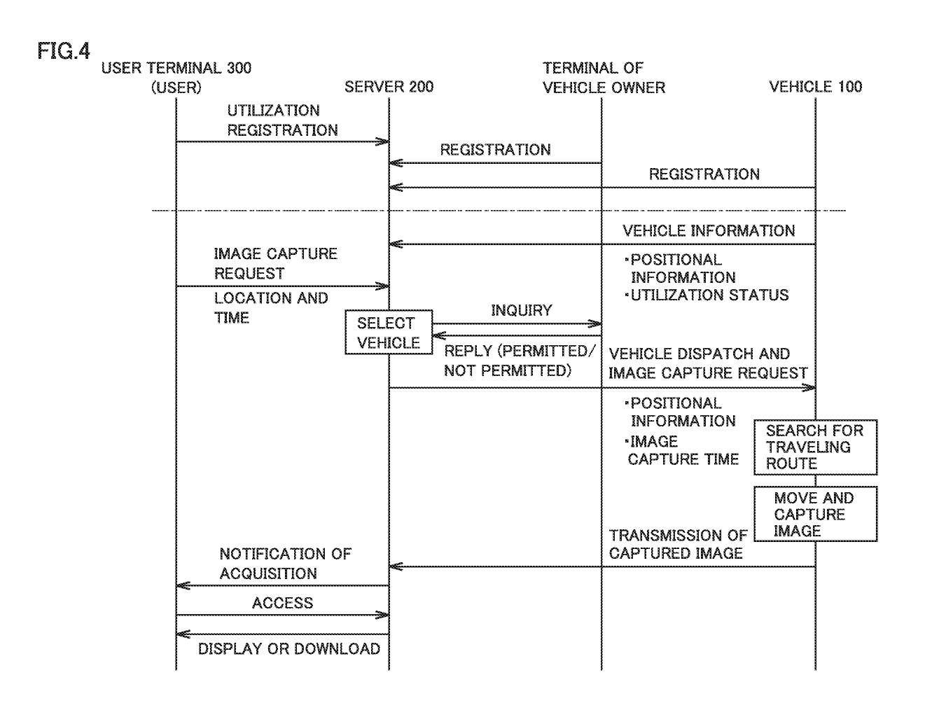

FIG. 4 is a sequence diagram showing exchange of information among respective elements (vehicle 100, server 200, user terminal 300) of image capture system 10 according to the present embodiment. FIG. 4 also shows a terminal of the owner of vehicle 100.

With reference to FIG. 4, the user who wishes to utilize image capture system 10 needs to make a utilization registration of the system in advance, and the information of the user is registered in server 200. Also, vehicle 100 to be utilized in image capture system 10 and the owner of vehicle 100 need to be registered in advance, and information of vehicle 100 and its owner (such as a contact address) is registered in server 200.

Vehicle 100 transmits the information of the vehicle to server 200. Specifically, vehicle 100 regularly transmits information such as its positional information (current position) or a utilization status (such as whether the vehicle is currently used or is not currently used by the owner, or the vehicle is during image capturing in response to an image capture request) to server 200. The vehicle information transmitted to server 200 is stored in vehicle information DB 222 of server 200.

The user who utilizes image capture system 10 makes an image capture request from user terminal 300. When the information (such as image capture location or image capture time) required for the image capture request is input to user terminal 300, user terminal 300 transmits image capture request information to server 200.

When receiving the image capture request information from user terminal 300, server 200 associates the received image capture request information with an ID of the user as the request information from the user, and stores this information in user information DB 221. Server 200 then refers to vehicle information DB 222 and map information DB 223 to select a vehicle 100 suitable for the image capture request while inquiring of the terminal of the owner of vehicle 100 about utilization of vehicle 100 for image capturing.

When a vehicle 100 is selected, server 200 transmits a vehicle dispatch and image capture request based on the image capture request to the selected vehicle 100. It should be noted that this vehicle dispatch and image capture request includes positional information on an image capture location and information such as image capture time.

Vehicle 100 that has received the dispatch and image capture request from server 200 searches for a traveling route from the position of vehicle 100 to an image capture location based on the positional information on the image capture location. Then, when a time to start moving which is calculated from the image capture time and the searched traveling route arrives, vehicle 100 moves to the image capture location in accordance with the searched traveling route, and camera 187 mounted on vehicle 100 captures an image of a situation outside vehicle 100.

Vehicle 100 that has captured an image of a situation outside the vehicle at the image capture location transmits a captured image to server 200. The captured image that has been transmitted to server 200 is associated with the ID of vehicle 100 that is a source of the image and is stored in image information DB 224 of server 200.

When vehicle 100 completes image capturing, server 200 transmits a notification indicating that an image has been obtained to user terminal 300 of the user who has made an image capture request. Then, the user who has received the notification can access server 200 using user terminal 300 to display the image stored in image information DB 224 of server 200 on user terminal 300 or download the image from server 200 to user terminal 300.

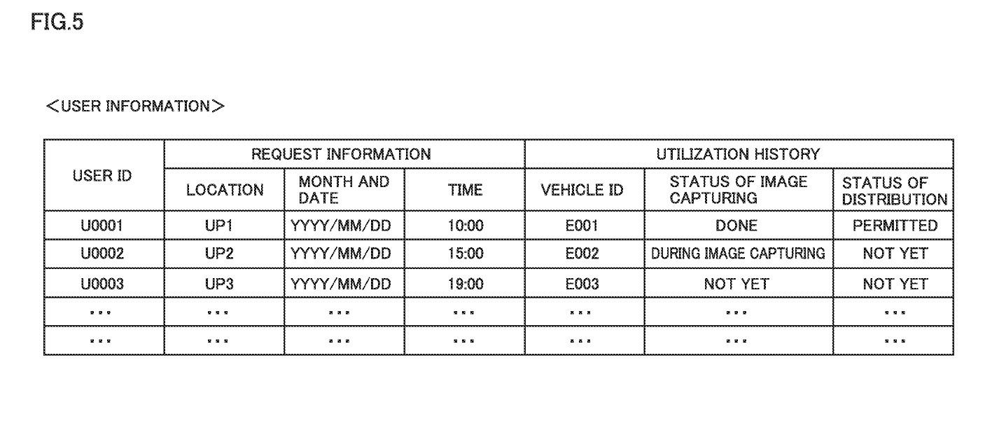

FIG. 5 shows a configuration of data stored in user information DB 221 of server 200. With reference to FIG. 5, a user ID is an identification number for specifying a user, and the request information based on the image capture request from user terminal 300 and the utilization history of vehicle 100 are associated with a user ID of a user who has made an image capture request.

Request information includes data on an image capture location and an image capture date and time that have been input when an image capture request has been made from user terminal 300. In this example, when an image capture request is received from user terminal 300, data is stored in request information associated with a user ID of a user who has made an image capture request. After a lapse of a predetermined period from the completion of image capturing, the data of the request information is erased (or may be moved to another location to be stored).

Utilization history includes data such as a vehicle ID of a vehicle 100 selected based on the request information associated with a user ID, a status of image capturing performed by vehicle 100, and a status of distribution of an image captured by vehicle 100 to the user. In one example, the following is shown for a user whose user ID is U0001: a vehicle 100 whose vehicle ID is E001 is selected, image capturing by vehicle 100 with E001 has been completed (status of image capturing “done”), and a captured image can be distributed to the user with U0001 (status of distribution “permitted”) who has made an image capture request.

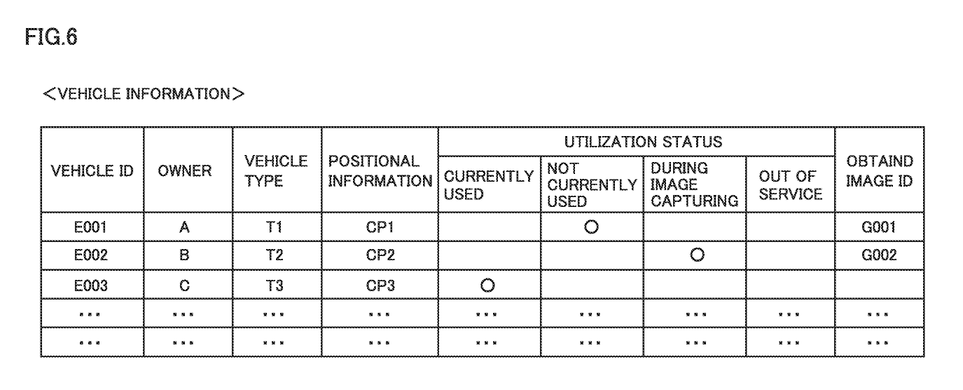

FIG. 6 shows a configuration of data stored in vehicle information DB 222 of server 200. With reference to FIG. 6, a vehicle ID is an identification number for specifying a vehicle 100, and various types of data indicating an owner of vehicle 100, a vehicle type, positional information (current position), utilization status, an obtained image ID, and the like are associated with a vehicle ID.

In vehicle information DB 222, the utilization status includes data about whether a vehicle 100 indicated by a vehicle ID is currently used or is not currently used, whether vehicle 100 is during image capturing, or whether vehicle 100 is out of service. “Currently used” means that vehicle 100 is currently used by its owner and vehicle 100 is in a driver-operated mode. “Not currently used” means that vehicle 100 is not currently used by its owner and vehicle 100 is in the driverless state (driverless mode). In the present embodiment, vehicle 100 can be utilized for image capturing based on an image capture request when vehicle 100 is in the driverless mode, as described later. “During image capturing” means that vehicle 100 is during image capturing based on an image capture request (which may include during moving to an image capture location or during moving to the owner after the completion of image capturing). “Out of service” means that, for example, vehicle 100 is out of service because the SOC of power storage device 110 of vehicle 100 has decreased or because power storage device 110 is currently charged by charger 150.

An obtained image ID is an identification number for specifying an image captured by a vehicle 100 indicated by a vehicle ID, and image data captured by this vehicle and stored in image information DB 224 is associated with the obtained image ID.

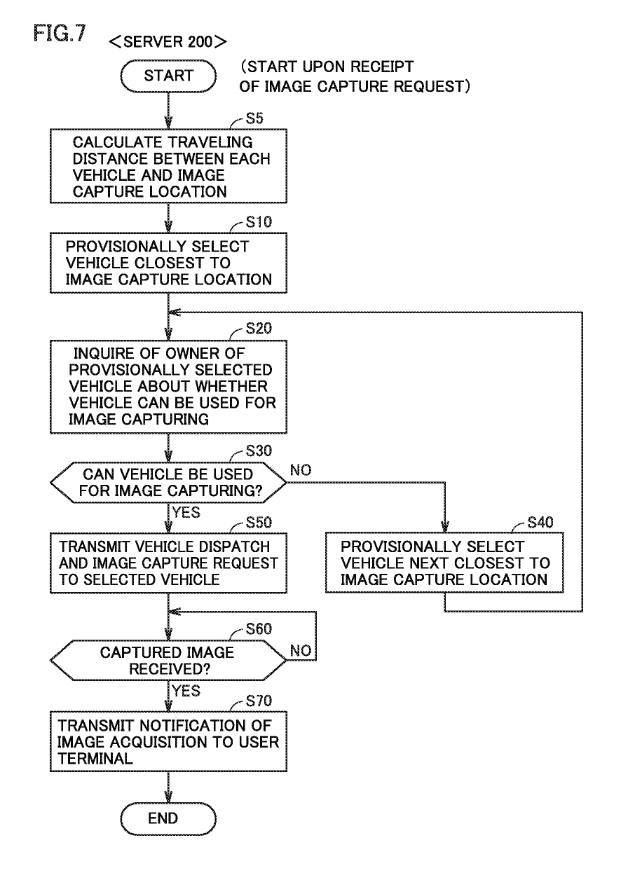

FIG. 7 is a flowchart for illustrating a procedure of processes performed by processor 230 of server 200. A series of processes shown in this flowchart are started upon receipt of an image capture request from user terminal 300.

With reference to FIG. 7, when receiving an image capture request from user terminal 300, server 200 (processor 230) associates information about the received image capture request with a user ID of a user as request information from the user, and stores this information in user information DB 221.

For each vehicle 100, server 200 subsequently reads a current position from vehicle information DB 222 and also reads an image capture location (position) of the request information from user information DB 221, and calculates a traveling distance between the current position of each vehicle 100 and an image capture location (step S5).

Subsequently, server 200 provisionally selects a vehicle 100 located closest to an image capture location (a vehicle 100 with the smallest distance to the image capture location) as a vehicle 100 to be dispatched to the image capture location based on the calculated traveling distance between each vehicle 100 and the image capture location (step S10).

Subsequently, server 200 inquires of the owner of the provisionally selected vehicle 100 about whether vehicle 100 can be utilized for image capturing (step S20). Specifically, server 200 transmits the inquiry to the terminal of the owner of the provisionally selected vehicle 100. Server 200 subsequently determines whether an image can be captured at the image capture location using vehicle 100 provisionally selected in step S10 (step S30).

When determining that an image cannot be captured using the provisionally selected vehicle 100 in step S30 (NO in step S30), server 200 provisionally selects a vehicle 100 next closest to the image capture location as a vehicle 100 to be dispatched to the image capture location (step S40). Server 200 subsequently returns the process to step S20 and performs each process of step S20 and step S30 again.

In contrast, when determining that an image can be captured using the provisionally selected vehicle 100 in step S30 (YES in step S30), server 200 transmits a vehicle dispatch and image capture request to the selected vehicle 100 (step S50). On this occasion, server 200 reads image capture request information (an image capture location and an image capture time) from user information DB 221, and transmits the information to the selected vehicle 100 together with the vehicle dispatch and image capture request.

Subsequently, vehicle 100 moves to the image capture location, and camera 187 mounted on vehicle 100 captures an image. Then, when receiving a captured image from vehicle 100 that has transmitted the vehicle dispatch and image capture request (YES in step S60), server 200 transmits a notification indicating that the image has been obtained based on the image capture request to user terminal 300 (step S70).

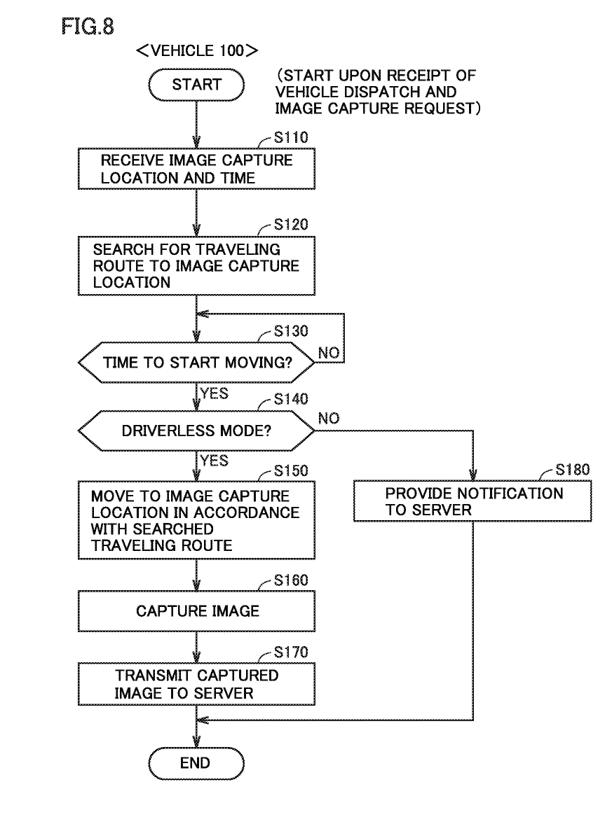

FIG. 8 is a flowchart for illustrating a procedure of processes performed by a controller 160 of vehicle 100. A series of processes shown in this flowchart are started upon receipt of a vehicle dispatch and image capture request from server 200. With reference to FIG. 8, controller 160 of vehicle 100 that has received the vehicle dispatch and image capture request from server 200 receives information on an image capture location and image capture time from server 200 together with the dispatch and image capture request (step S110).

Controller 160 subsequently searches for a traveling route to the image capture location using navigation device 185 based on the positional information on the image capture location received together with the vehicle dispatch and image capture request in step S110 (step S120).

When a time to start moving to the image capture location which is calculated from the image capture time and the searched traveling route arrives (YES in step S130), controller 160 determines whether this vehicle 100 is in the driverless mode (step S140).

When determining that vehicle 100 is in the driverless mode (YES in step S140), controller 160 travels from the current position to the image capture location in accordance with the traveling route searched in step S120 (step S150). When vehicle 100 arrives at the image capture location, controller 160 then captures an image of an outside situation by camera 187 (step S160), and transmits the image captured by camera 187 to server 200 (step S170). When image capturing at the image capture location completes, controller 160 moves to the owner of vehicle 100, which is not particularly shown.

In contrast, when determining that vehicle 100 is not in the driverless mode in step S140 (NO in step S140), controller 160 determines that vehicle 100 is currently used by its owner, provides this notification to server 200 (step S180), and then proceeds to END. That is, since vehicle 100 is currently used by its owner in this case, controller 160 provides this notification to server 200 and does not perform the processes of step S150 to step S170.

As described above, according to the present embodiment, vehicle 100 can move to an image capture location adhering to an image capture request and obtain an image (which may be a still image or a moving image) of that location. For example, vehicle 100 moves to a location impacted by a disaster, a location with a windstorm associated with an approaching typhoon, or any other location and captures an image of such a location. This allows a user to remotely view the image of the location without actually visiting the location.

According to the present embodiment, since a vehicle 100 closest to the image capture location is used for image capturing adhering to an image capture request, vehicle 100 can be moved to the image capture location adhering to the image capture request on the shortest route to obtain an image of that location.

According to the present embodiment, a vehicle 100 is used for image capturing adhering to an image capture request when vehicle 100 is in the driverless mode. This enables effective utilization of vehicle 100 in the driverless state which is not used by the owner without inhibiting the utilization of vehicle 100 by the owner of vehicle 100.

According to the present embodiment, a vehicle 100 is used for image capturing adhering to an image capture request when the owner of vehicle 100 permits the use of vehicle 100 for image capturing. This prevents vehicle 100 from moving to the image capture location adhering to an image capture request against the intention of the owner of vehicle 100.

### Modification

In the embodiment above, when a vehicle 100 determines that vehicle 100 is in the driverless mode, vehicle 100 moves to an image capture location and captures images. In a modification, server 200 may extract vehicles 100 which are not currently used (in the driverless state) with reference to vehicle information DB 222 and select a vehicle 100 that can be used for image capturing from among the extracted vehicles 100.

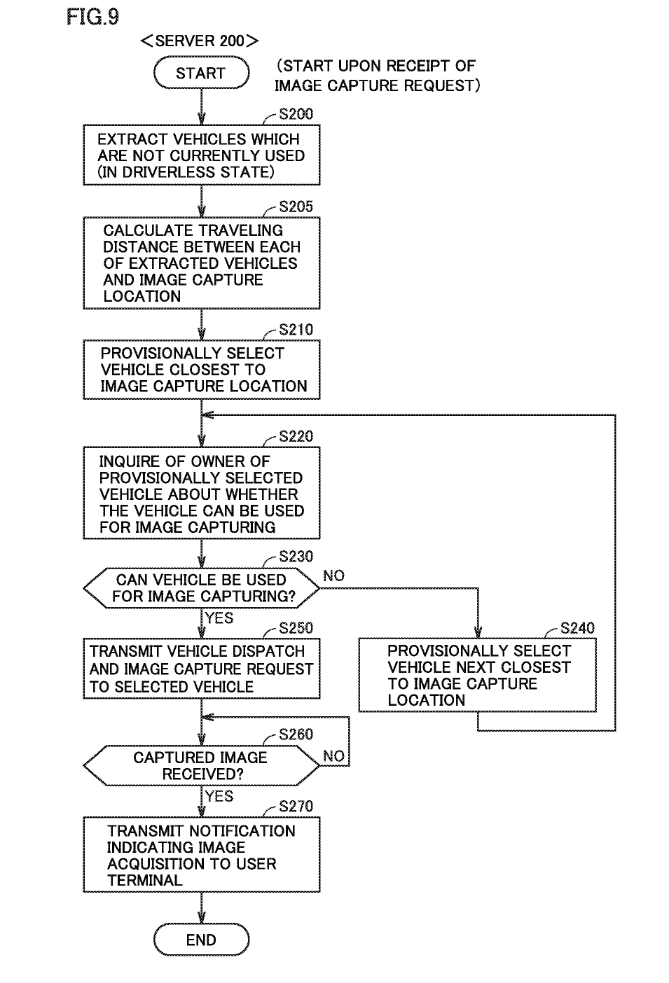

FIG. 9 is a flowchart for illustrating a process of processes performed by processor 230 of server 200 in the modification. This flowchart corresponds to the flowchart in the above embodiment which has been shown in FIG. 7, and a series of processes shown in this flowchart are also started upon receipt of an image capture request from user terminal 300.

With reference to FIG. 9, when receiving an image capture request from user terminal 300, server 200 (processor 230) associates information on the received image capture request with a user ID of a user as request information from the user and stores this information in user information DB 221. Server 200 subsequently extracts vehicles 100 which are not currently used, that is, which are in the driverless state (driverless mode) with reference to the utilization status of each vehicle 100 of vehicle information DB 222 (step S200).

Server 200 subsequently calculates a traveling distance between the current position of each of the extracted vehicles 100 and the image capture location (step S205). Then, server 200 provisionally selects a vehicle 100 located closest to the image capture location (a vehicle 100 with the shortest distance to the image capture location) as a vehicle 100 to be dispatched to the image capture location based on the calculated traveling distance between each vehicle 100 and the image capture location (step S210).

It should be noted that since the processes performed in step S210 to step S270 are identical to the processes performed in step S10 to step S70, respectively, shown in FIG. 7, description thereof will not be repeated.

A vehicle 100 that has received a vehicle dispatch and image capture request from a server 200 moves to the image capture location in the driverless mode and, after the completion of image capturing at the image capture location, moves to the owner of vehicle 100 in the driverless mode, which will not be particularly shown.

According to this modification, server 200 extracts vehicles 100 which are not currently used (in the driverless state) and selects a vehicle 100 that can be used for image capturing from among the extracted vehicles 100, as described above. This can reduce a risk that the selected vehicle 100 cannot be used for image capturing because, for example, it is currently used by its owner.

Although the present disclosure has been described and illustrated in detail, it is clearly understood that the same is by way of illustration and example only and is not to be taken by way of limitation, the scope of the present disclosure being interpreted by the terms of the appended claims.

What is claimed is:

1. A movable body configured to perform automated driving, comprising:
an image capturing device configured to capture an image of a situation outside the movable body;
a communication device configured to communicate outside of the movable body; and
a controller configured to receive an image capture request including an image capture location through the communication device,
wherein the controller is configured to perform, in accordance with the image capture request, control for causing the movable body to move to the image capture location and capturing an image of a situation outside the movable body by the image capturing device.

2. The movable body according to claim 1, wherein
the movable body is configured to perform driverless driving, and
the controller is configured to perform the control in accordance with the image capture request during a driverless mode in which the movable body is caused to travel by the driverless driving.

3. The movable body according to claim 1, wherein the controller is configured to perform the control in accordance with the image capture request when an owner of the movable body permits execution of the control.

4. An image capture system using a movable body, the image capture system comprising:
a plurality of movable bodies each configured to perform automated driving; and
a server configured to communicate with the plurality of movable bodies, wherein
each of the plurality of movable bodies includes an image capturing device configured to capture an image of a situation outside the movable body,
the server is configured to
when receiving an image capture request including an image capture location, select an image capture movable body capable of moving to the image capture location in accordance with the image capture request from among the plurality of movable bodies, and
transmit, to the image capture movable body, an instruction for moving the image capture movable body to the image capture location and capturing an image of a situation outside the image capture movable body by the image capturing device, and
the image capture movable body is configured to transmit, to the server, an image captured by the image capturing device in accordance with the instruction.

5. The image capture system according to claim 4, wherein the server is configured to select a movable body closest to the image capture location from among the plurality of movable bodies as the image capture movable body.

6. The image capture system according to claim 4, wherein
each of the plurality of movable bodies is configured to perform driverless driving, and
the server is configured to select the image capture movable body from among movable bodies in a driverless mode that causes a movable body to travel by the driverless driving.

7. The image capture system according to claim 4, wherein the server is configured to select, as the image capture movable body, a movable body permitted to perform image capturing adhering to the image capture request by an owner of the movable body from among the plurality of movable bodies.

8. A server comprising:
a communication device configured to communicate with a plurality of movable bodies each configured to perform automated driving; and
a processor, wherein
each of the plurality of movable bodies includes an image capturing device configured to capture an image of a situation outside the movable body, and
the processor is configured to
when receiving an image capture request including an image capture location through the communication device, select an image capture movable body capable of moving to the image capture location in accordance with the image capture request from among the plurality of movable bodies, and
transmit, through the communication device to the image capture movable body, an instruction for moving the image capture movable body to the image capture location and capturing an image of a situation outside the image capture movable body by the image capturing device.

9. An image capturing method using a movable body configured to perform automated driving,
the movable body including an image capturing device configured to capture an image of a situation outside the movable body,
the method comprising:
receiving an image capture request including an image capture location;
causing the movable body to move to the image capture location in accordance with the image capture request; and
causing the image capturing device to capture an image of a situation outside the movable body at the image capture location.
